(19) United States
(12) Patent Application Publication
(10) Pub. No.: US 2026/0067339 A1
(43) Pub. Date: Mar. 5, 2026

(54) APPARATUS AND METHOD FOR PDU SESSION MANAGEMENT IN WIRELESS COMMUNICATION SYSTEM

(71) Applicant: ELECTRONICS AND TELECOMMUNICATIONS RESEARCH INSTITUTE, Daejeon (KR)

(72) Inventors: Seung Han CHOI, Daejeon (KR); Quang Tung THAI, Daejeon (KR); Namseok KO, Daejeon (KR)

(73) Assignee: ELECTRONICS AND TELECOMMUNICATIONS RESEARCH INSTITUTE, Daejeon (KR)

(21) Appl. No.: 19/287,441

(22) Filed: Jul. 31, 2025

(30) Foreign Application Priority Data
Aug. 28, 2024 (KR) 10-2024-0115753
Nov. 1, 2024 (KR) 10-2024-0153379
Jun. 17, 2025 (KR) 10-2025-0079171

(51) Int. Cl. H04L 65/1069; H04L 41/122; H04L 69/322

(52) U.S. Cl. CPC H04L 65/1069; H04L 41/122; H04L 69/322

(57) ABSTRACT

In a method for establishing a PDU session, the method includes: receiving, by an SMF, a PDU session creation request message from an AMF; decrypting, by the SMF, a PDU session establishment request through an SMF-related key and generating a mapping table; performing an association procedure by selecting a PCF and at least one UPF based on the decrypted PDU session establishment request; and encrypting a PDU session establishment accept through the SMF-related key and transmitting a PDU session resource setup including the PDU session establishment accept to a base station.

### CROSS REFERENCE TO RELATED APPLICATION

This application claims priority to Korean Patent Application No. 10-2024-0115753, filed on Aug. 28, 2024, Korean Patent Application No. 10-2024-0153379, filed on Nov. 1, 2024, and Korean Patent Application No. 10-2025-0079171, filed on Jun. 17, 2025, the entire contents of which are hereby incorporated by reference.

### BACKGROUND OF THE INVENTION

### Field of the Invention

The present disclosure relates to a method and apparatus for managing PDU (protocol data unit) sessions in a mobile communication system. Specifically, it relates to a method and apparatus for establishing, modifying, and releasing PDU sessions.

### Description of the Related Art

With the emergence of new services such as 5G, cloud, and IoT (internet of things), future application services require network technologies that provide stronger programmability and simpler integrated network solutions. 5G has been developed based on service scenarios of Enhanced Mobile Broadband (eMBB), massive Machine Type Communication (mMTC), and Ultra-Reliable Low Latency (uRLLC) communication.

However, the need for providing various types of services is increasing, and there may be limitations to existing architectures in providing complex services. Considering the above points, a Service-based Architecture (SBA) can be considered as a new architecture. For example, an SBA network can integrate cutting-edge technologies such as Network function virtualization (NFV), Software-Defined Networking (SDN), Multi-Access Edge Computing (MEC), and network slicing. The following describes a method for managing PDU sessions based on existing networks and SBA.

### SUMMARY OF THE INVENTION

The present disclosure relates to a method and apparatus for managing PDU sessions.

The present disclosure relates to a method and apparatus for managing PDU sessions through SBI (Service-Based Interface) based on SBA.

The present disclosure relates to a method and apparatus for managing PDU sessions by directly exchanging messages between a base station and SMF (Session Management Function) based on SBI.

The present disclosure relates to a method and apparatus for establishing, modifying, and releasing PDU sessions based on SBI.

The technical objectives to be achieved by the present disclosure are not limited to the matters mentioned above, and other technical challenges not mentioned can be considered by those skilled in the art to which the technical configuration of the present disclosure applies from the embodiments of the present disclosure described below.

According to one embodiment, in a method for establishing a PDU (protocol data unit) session, the method includes: receiving, by an SMF (session management function), a PDU session creation request message from an AMF (access management function), wherein the PDU session creation request message includes an SMF-related key and a PDU session establishment request; decrypting, by the SMF, the PDU session establishment request through the SMF-related key and generating a mapping table; performing an association procedure by selecting a PCF (policy control function) and at least one UPF (user plane function) based on the decrypted PDU session establishment request; and encrypting establishment accept through the SMF-related key and transmitting a PDU session resource setup including the PDU session establishment accept to a base station.

According to one embodiment, an apparatus for establishing a PDU session includes: a memory storing at least one program; a transceiver for transmitting and receiving at least one signal; and a processor executing at least one program stored in the memory, wherein the processor receives a PDU session creation request message from an AMF (access management function), wherein the PDU session creation request message includes an SMF-related key and a PDU session establishment request, decrypts the PDU session establishment request through the SMF-related key and generates a mapping table, performs an association procedure by selecting a PCF (policy control function) and at least one UPF (user plane function) based on the decrypted PDU session establishment request, and encrypts a PDU session establishment accept through the SMF-related key and transmits a PDU session resource setup including the PDU session establishment accept to a base station.

Additionally, the following matters can be commonly applied.

According to one embodiment, each of at least one network function (NF) and the base station can directly exchange communication-related messages based on a service based interface (SBI).

According to one embodiment, each of the at least one NFs and the base station is virtualized as a software configuration, and each of the at least one NFs and the base station can directly exchange communication-related messages in the SBI through an API (application programming interface).

According to one embodiment, a user equipment (UE) and the AMF possess an AMF-related key, wherein the SMF-related key is generated by the UE based on the AMF-related key and a random number value, a message encrypted through the AMF-related key and a PDU session creation request encrypted through the SMF-related key are included in a PDCP (packet data convergence protocol) message and delivered to the base station, the message encrypted through the AMF-related key includes the random number value, the base station delivers a message including the message encrypted through the AMF-related key and the PDU session creation request encrypted through the SMF-related key to the AMF, the AMF decrypts the message encrypted through the AMF-related key using the AMF-related key to obtain the random number value, generates the SMF-related key through the random number value and the possessed AMF-related key, and delivers the generated SMF-related key and the PDU session creation request encrypted through the SMF-related key to the SMF.

According to one embodiment, the SMF can decrypt the PDU session establishment request encrypted through the SMF-related key using the received SMF-related key.

According to one embodiment, when the established PDU session is modified, the SMF receives a PDU session modification request encrypted through the SMF-related key, decrypts it using the SMF-related key, performs a PDU session modification procedure with the at least one UPFs based on the decrypted PDU session modification request, and encrypts a PDU session modification command through the SMF-related key and directly delivers it to the base station.

According to one embodiment, the UE encrypts a PDU session modification request through the SMF-related key, delivers a PDCP message including the encrypted PDU session modification request to the base station, and the base station directly delivers the PDU session modification request encrypted through the SMF-related key to the SMF based on the SBI.

According to one embodiment, when the established PDU session is released, the SMF receives a PDU session release request encrypted through the SMF-related key, decrypts it using the SMF-related key, performs a PDU session release procedure with the PCF and the at least one UPFs based on the PDU session release request, and encrypts a PDU session release command through the SMF-related key and directly delivers it to the base station.

According to one embodiment, the UE encrypts a PDU session release request through the SMF-related key, delivers a PDCP message including the encrypted PDU session release request to the base station, and the base station directly delivers the PDU session modification request encrypted through the SMF-related key to the SMF based on the SBI.

According to one embodiment, the base station delivers the PDU session release command encrypted through the SMF-related key to the UE, the UE decrypts and confirms the PDU session release command through the SMF-related key, encrypts a PDU session release complete through the SMF-related key, delivers a PDCP message including the encrypted PDU session release complete to the base station, the base station directly delivers the PDU session release complete encrypted through the SMF-related key to the SMF, and the SMF decrypts the PDU session release complete encrypted through the SMF-related key using the SMF-related key.

According to one embodiment, the SMF can indicate PDU session release completion to the AMF.

According to one embodiment, in a method for establishing a PDU (protocol data unit) session, the method includes: generating, by a user equipment (UE), an SMF (session management function)-related key, wherein the UE generates the SMF-related key based on an AMF-related key and a random number value; delivering a PDCP (packet data convergence protocol) message including a message encrypted through the AMF-related key and a PDU session establishment request encrypted through the SMF-related key to a base station, wherein the message encrypted through the AMF-related key includes the random number value; receiving a PDCP message including a PDU session establishment accept encrypted through the SMF key; and decrypting the PDU session establishment accept through the SMF key.

According to one embodiment, an apparatus for establishing a PDU session includes: a memory storing at least one program; a transceiver for transmitting and receiving at least one signal; and a processor executing at least one program stored in the memory, wherein the processor generates an SMF (session management function)-related key, wherein the UE generates the SMF-related key based on an AMF-related key and a random number value, delivers a PDCP (packet data convergence protocol) message including a message encrypted through the AMF-related key and a PDU session establishment request encrypted through the SMF-related key to a base station, wherein the message encrypted through the AMF-related key includes the random number value, receives a PDCP message including a PDU session establishment accept encrypted through the SMF key, and decrypts the PDU session establishment accept through the SMF key.

Additionally, the following matters can be commonly applied.

According to one embodiment, each of at least one network function (NF) and the base station can directly exchange communication-related signals based on a service based interface (SBI).

According to one embodiment, the base station can deliver a message including the message encrypted through the AMF-related key and the PDU session establishment request encrypted through the SMF-related key to the AMF based on the SBI.

According to one embodiment, the base station can directly obtain a message including the PDU session establishment accept encrypted through the SMF key from the SMF based on the SBI.

According to one embodiment, when the established PDU session is modified, the UE encrypts a PDU session modification request through the SMF-related key and delivers it to the base station, the base station directly delivers a message including the PDU session modification request encrypted through the SMF-related key to the SMF, and receives a message including a PDU session modification command encrypted through the SMF key from the SMF to deliver the PDU session modification command to the UE.

According to one embodiment, when the established PDU session is released, the UE encrypts a PDU session release request through the SMF-related key and delivers it to the base station, the base station directly delivers a message including the PDU session release request encrypted through the SMF-related key to the SMF, and receives a message including a PDU session release command encrypted through the SMF key from the SMF to deliver the PDU session release command to the UE.

The present disclosure has the effect of providing a method for managing PDU sessions.

The present disclosure has the effect of providing a method for managing PDU sessions through SBI based on SBA.

The present disclosure has the effect of providing a method for managing PDU sessions by directly exchanging messages between a base station and SMF based on SBI.

The present disclosure has the effect of providing a method for establishing, modifying, and releasing PDU sessions based on SBI.

The effects obtainable from the embodiments of the present disclosure are not limited to the effects mentioned above, and other effects not mentioned can be clearly derived and understood by those skilled in the art to which the technical configuration of the present disclosure applies from the description of the embodiments of the present disclosure below. That is, unintended effects from implementing the configurations described in the present disclosure can also be derived by those skilled in the art from the embodiments of the present disclosure.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a conceptual diagram illustrating a mobile communication system according to one embodiment.

FIG. 2 is a diagram showing a device configuration according to one embodiment.

FIG. 3 is a diagram showing reference points according to one embodiment.

FIG. 4 is a diagram showing operations between network functions and service controllers according to one embodiment.

FIG. 5 is a diagram showing a method of operating based on a service-based interface according to one embodiment.

FIG. 6 is a diagram showing a service-based interface based on an SBI structure according to one embodiment.

FIG. 7 is a diagram showing a structure in which base station functions are connected to SBI based on API according to one embodiment.

FIGS. 8A to 8C are diagrams showing a method for a terminal to establish, modify, and release a PDU session according to one embodiment.

FIGS. 9A to 9C are diagrams showing a method for a terminal to establish, modify, and release a PDU session according to one embodiment.

FIG. 10 is a flowchart showing a method for an SMF to establish a PDU session according to one embodiment.

FIG. 11 is a flowchart showing a method for an SMF to establish a PDU session according to one embodiment.

### DETAILED DESCRIPTION OF THE INVENTION

The embodiments of the present disclosure will be described in detail below with reference to the accompanying drawings so that those skilled in the art to which the present invention belongs can easily implement them. However, the present disclosure may be implemented in various different forms and is not limited to the embodiments described herein. In the drawings, parts irrelevant to the description are omitted to clearly describe the present disclosure, and similar reference numerals are assigned to similar parts throughout the specification.

Throughout the specification, a terminal may refer to user equipment (UE), mobile station (MS), mobile terminal (MT), advanced mobile station (AMS), high reliability mobile station (HR-MS), subscriber station (SS), portable subscriber station (PSS), access terminal (AT), machine type communication device (MTC device), etc., and may include all or part of the functions of UE, MS, MT, AMS, HR-MS, SS, PSS, AT, etc.

Additionally, a base station (BS) may refer to node B, evolved node B (eNB), gNB, advanced base station (ABS), high reliability base station (HR-BS), access point (AP), radio access station (RAS), base transceiver station (BTS), MMR (mobile multihop relay)-BS, relay station (RS) performing the role of a base station, relay node (RN) performing the role of a base station, advanced relay station (ARS) performing the role of a base station, high reliability relay station (HR-RS) performing the role of a base station, small base stations [femto base station (femto BS), home node B (HNB), home eNodeB (HeNB), pico base station (pico BS), macro base station (macro BS), micro base station (micro BS), etc.], etc., and may include all or part of the functions of NB, eNB, gNB, ABS, AP, RAS, BTS, MMR-BS, RS, RN, ARS, HR-RS, small base stations, etc.

Throughout the specification, when a part “includes” a component, this means that it may further include other components rather than excluding other components unless specifically stated otherwise.

In this specification, phrases such as “A or B”, “at least one of A and B”, “at least one of A or B”, “A, B or C”, “at least one of A, B and C”, and “at least one of A, B, or C” may each include any one of the items listed together in the corresponding phrase, or all possible combinations thereof.

Expressions described in the singular in this specification may be interpreted as singular or plural unless explicit expressions such as “one” or “single” are used.

In this specification, “and/or” includes each and all combinations of one or more of the mentioned components.

In this specification, terms including ordinal numbers such as first, second, etc. may be used to describe various components, but the components are not limited by the terms. The terms are used only for the purpose of distinguishing one component from another component. For example, a first component may be referred to as a second component without departing from the scope of the present disclosure, and similarly, a second component may also be referred to as a first component.

In the flowcharts described with reference to the drawings in this specification, the order of operations may be changed, multiple operations may be merged, any operation may be divided, and specific operations may not be performed.

A communication network to which embodiments according to this specification are applied will be described. The communication network may be a 4G communication network (e.g., long-term evolution (LTE) communication network), a 5G communication network (e.g., new radio (NR) communication network), a non-terrestrial network (NTN), etc. Throughout the specification, a network may include, for example, wireless internet such as WiFi (wireless fidelity), portable internet such as WiBro (wireless broadband internet) or WiMax (world interoperability for microwave access), 2G mobile communication networks such as GSM (global system for mobile communication) or CDMA (code division multiple access), 3G mobile communication networks such as WCDMA (wideband code division multiple access) or CDMA2000, 3.5G mobile communication networks such as HSDPA (high speed downlink packet access) or HSUPA (high speed uplink packet access), 4G mobile communication networks such as LTE (long term evolution) networks or LTE-Advanced networks, and 5G mobile communication networks.

Throughout the specification, a terminal may be referred to as a terminal, access terminal, mobile terminal, station, subscriber station, mobile station, portable subscriber station, node, device, etc.

Here, devices capable of communication as terminals may include desktop computers, laptop computers, tablet PCs, wireless phones, mobile phones, smart phones, smart watches, smart glasses, e-book readers, PMPs (portable multimedia players), portable gaming devices, navigation devices, digital cameras, DMB (digital multimedia broadcasting) players, digital audio recorders, digital audio players, digital picture recorders, digital picture players, digital video recorders, digital video players, etc.

Throughout the specification, a base station may be referred to as NodeB, evolved NodeB, BTS (base transceiver station), radio base station, radio transceiver, access point, access node, road side unit (RSU), digital unit (DU), cloud digital unit (CDU), radio remote head (RRH), radio unit (RU), transmission point (TP), transmission and reception point (TRP), relay node, etc.

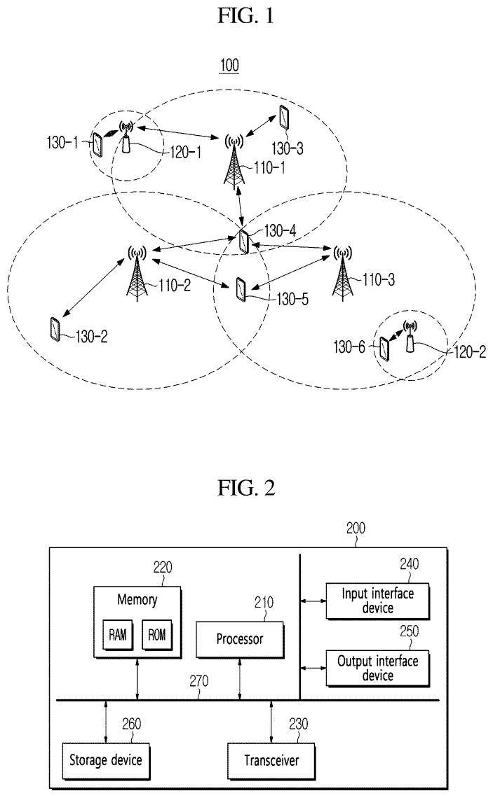

FIG. 1 is a conceptual diagram illustrating a mobile communication system according to one embodiment.

Referring to FIG. 1, a communication system 100 may include a plurality of communication nodes 110-1, 110-2, 110-3, 120-1, 120-2, 130-1, 130-2, 130-3, 130-4, 130-5, 130-6. The plurality of communication nodes may support 4G communication (e.g., long term evolution (LTE), LTE-A (advanced)), 5G communication (e.g., new radio (NR)), etc. specified in the 3GPP (3rd generation partnership project) standard. 4G communication may be performed in frequency bands below 6 GHZ, and 5G communication may be performed in frequency bands below 6 GHz as well as frequency bands above 6 GHz.

For example, for 4G communication and 5G communication, the plurality of communication nodes may support communication protocols based on CDMA (code division multiple access), WCDMA (wideband CDMA), TDMA (time division multiple access), FDMA (frequency division multiple access), OFDM (orthogonal frequency division multiplexing), Filtered OFDM, CP (cyclic prefix)-OFDM, DFT-S-OFDM (discrete Fourier transform-spread-OFDM), OFDMA (orthogonal frequency division multiple access), SC (single carrier)-FDMA, NOMA (Non-orthogonal Multiple Access), GFDM (generalized frequency division multiplexing), FBMC (filter bank multi-carrier), UFMC (universal filtered multi-carrier), SDMA (Space Division Multiple Access), etc.

Additionally, the communication system 100 may further include a core network. When the communication system 100 supports 4G communication, the core network may include S-GW (serving-gateway), P-GW (PDN (packet data network)-gateway), MME (mobility management entity), etc. When the communication system 100 supports 5G communication, the core network may include UPF (user plane function), SMF (session management function), AMF (access and mobility management function), etc.

Meanwhile, each of the plurality of communication nodes 110-1, 110-2, 110-3, 120-1, 120-2, 130-1, 130-2, 130-3, 130-4, 130-5, 130-6 (or network functions) constituting the communication system 100 may have the following structure.

FIG. 2 is a diagram showing a device configuration according to one embodiment.

Referring to FIG. 2, a communication node 200 (network function) may include at least one processor 210, memory 220, and a transceiver 230 connected to a network to perform communication. Additionally, the communication node 200 may further include an input interface device 240, an output interface device 250, a storage device 260, etc. Each component included in the communication node 200 may be connected by a bus 270 to communicate with each other.

However, each component included in the communication node 200 may be connected through individual interfaces or individual buses centered on the processor 210, rather than the common bus 270. For example, the processor 210 may be connected to at least one of the memory 220, transceiver 230, input interface device 240, output interface device 250, and storage device 260 through dedicated interfaces.

The processor 210 may execute program commands stored in at least one of the memory 220 and storage device 260. The processor 210 may mean a central processing unit (CPU), graphics processing unit (GPU), or a dedicated processor on which methods according to embodiments of the present invention are performed. Each of the memory 220 and storage device 260 may be composed of at least one of volatile storage media and non-volatile storage media. For example, the memory 220 may be composed of at least one of read only memory (ROM) and random access memory (RAM).

Referring again to FIG. 1, the communication system 100 may include a plurality of base stations 110-1, 110-2, 110-3, 120-1, 120-2 and a plurality of terminals 130-1, 130-2, 130-3, 130-4, 130-5, 130-6. The communication system 100 including base stations 110-1, 110-2, 110-3, 120-1, 120-2 and terminals 130-1, 130-2, 130-3, 130-4, 130-5, 130-6 may be referred to as an “access network”. Each of the first base station 110-1, second base station 110-2, and third base station 110-3 may form a macro cell. Each of the fourth base station 120-1 and fifth base station 120-2 may form a small cell. The fourth base station 120-1, third terminal 130-3, and fourth terminal 130-4 may belong to the cell coverage of the first base station 110-1. The second terminal 130-2, fourth terminal 130-4, and fifth terminal 130-5 may belong to the cell coverage of the second base station 110-2. The fifth base station 120-2, fourth terminal 130-4, fifth terminal 130-5, and sixth terminal 130-6 may belong to the cell coverage of the third base station 110-3. The first terminal 130-1 may belong to the cell coverage of the fourth base station 120-1. The sixth terminal 130-6 may belong to the cell coverage of the fifth base station 120-2.

Here, each of the plurality of base stations 110-1, 110-2, 110-3, 120-1, 120-2 may be referred to as NodeB, evolved NodeB, gNB, xNB, BTS (base transceiver station), radio base station, radio transceiver, access point, access node, etc. Each of the plurality of terminals 130-1, 130-2, 130-3, 130-4, 130-5, 130-6 may be referred to as UE (user equipment), terminal, access terminal, mobile terminal, station, subscriber station, mobile station, portable subscriber station, node, device, etc.

Meanwhile, each of the plurality of base stations 110-1, 110-2, 110-3, 120-1, 120-2 may operate in different frequency bands or may operate in the same frequency band. Each of the plurality of base stations 110-1, 110-2, 110-3, 120-1, 120-2 may be connected to each other through ideal backhaul links or non-ideal backhaul links and may exchange information with each other through ideal backhaul links or non-ideal backhaul links. Each of the plurality of base stations 110-1, 110-2, 110-3, 120-1, 120-2 may be connected to the core network through ideal backhaul links or non-ideal backhaul links. Each of the plurality of base stations 110-1, 110-2, 110-3, 120-1, 120-2 may transmit signals received from the core network to corresponding terminals 130-1, 130-2, 130-3, 130-4, 130-5, 130-6 and may transmit signals received from corresponding terminals 130-1, 130-2, 130-3, 130-4, 130-5, 130-6 to the core network.

As an example, the 5G system is composed of an architecture based on interactions between network functions (NFs). As an example, 5GC as the core network of the 5G system may include various entities. Specifically, AMF (access and mobility management function) can manage access and mobility of terminals. Additionally, AMF can perform the function of managing NAS (non-access stratum) security. Additionally, AMF can perform the function of handling mobility of idle terminals.

Additionally, SMF (session management function) can manage sessions. As an example, SMF performs the function of allocating terminal IP (Internet protocol) addresses and can control PDU (protocol data unit) sessions.

Additionally, PCF (policy control function) can perform the function of controlling policies. Additionally, it may include UPF (user plane function) that performs the function of controlling the user plane. UPF functions as a gateway for transmitting and receiving data and can perform all or part of the user plane functions of S-GW (serving gateway) and P-GW (packet data network gateway) of previous mobile communication systems (4G). Additionally, UPF can perform the function of handling PDUs. Additionally, it may include AF (application function) that controls application functions. AF may be a function for providing multiple services to terminals. Additionally, it may include UDM (unified data management) that manages integrated data. Here, UDM can perform the function of managing subscriber information.

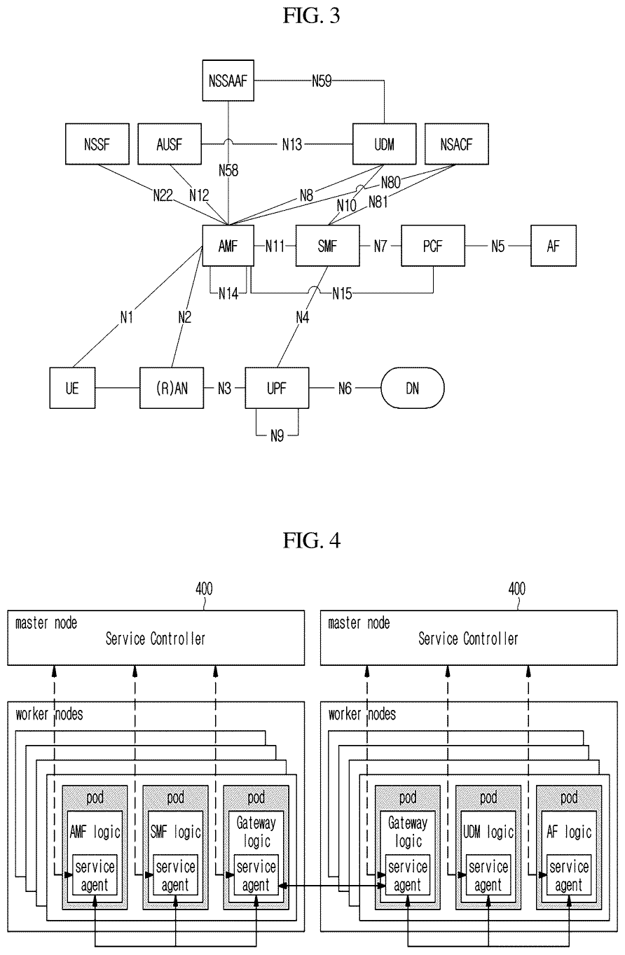

FIG. 3 is a diagram showing reference points according to one embodiment.

Referring to FIG. 3, reference points may represent interactions between NF services within NEs described by point-to-point reference points between two network functions (NFs). As an example, N1 may be a reference point between UE and AMF (Access Management Function). N2 may be a reference point between (R)AN and AMF. N3 may be a reference point between (R)AN and UPF (User Plane Function). Other reference points may be as shown in Table 1 below, but may not be limited thereto.

TABLE 1
N1: Reference point between the UE and the AMF.
N2: Reference point between the (R)AN and the AMF.
N3: Reference point between the (R)AN and the UPF.
N4: Reference point between the SMF and the UPF.
N5: Reference point between the PCF and an AF or TSN AF.
N6: Reference point between the UPF and a Data Network.
N7: Reference point between the SMF and the PCF.
N8: Reference point between the UDM and the AMF.
N9: Reference point between two UPFs.
N10: Reference point between the UDM and the SMF.
N11: Reference point between the AMF and the SMF.
N12: Reference point between AMF and AUSF.
N13: Reference point between the UDM and Authentication Server
function the AUSF.
N14: Reference point between two AMFs.
N15: Reference point between the PCF and the AMF in the case of
non-roaming scenario, PCF in the visited network and AMF in the case of
roaming scenario.
N16: Reference point between two SMFs, (in roaming case between SMF
in the visited network and the SMF in the home network).
N16a: Reference point between SMF and I-SMF.
N17: Reference point between AMF and 5G-EIR.
N18: Reference point between any NF and UDSF.
N19: Reference point between two PSA UPFs for 5G LAN-type service.
N22: Reference point between AMF and NSSF.

The 5G mobile core described in FIGS. 1 to 3 above is designed as a single structure, but in post-5G (e.g. 6G), there is a need for the core network to be designed as a service-based architecture. As an example, the network may be composed of network functions, which are software components that operate based on interactions, thereby providing horizontal scalability and flexibility to meet various detailed requirements. Additionally, the mobile core network can operate based on maturing cloud-native technology where network functions are deployed in multiple distributed clouds. Here, the current 5G mobile core structure has limitations in supporting cloud-native technology, so a paradigm change may be necessary. Considering the above points, the core network can be designed as a service based architecture (SBA) based network. An SBA-based core network can be decomposed and included as network functions (NFs), which are software components with various functions. Here, NFs can expose services in the form of restful (application programming interface). That is, when the network is decomposed into NFs, which are software components, flexible and scalable deployment may be possible, thereby having a service-based structure. Additionally, as an example, in an SBA-based core network, NFs can be containerized and deployed in multiple clouds, and through cloud technology, resources can be shared and services can be dynamically allocated for service operations. Through the above, a flexible and scalable core network can be built, and various services can be provided through this.

As an example, various types of services are expected to emerge after 5G, and considering the above services, the core network needs to be designed based on SBA. The following describes an operation method in an SBA-based core network considering the above points. Based on the current 5G core network, signal procedures for terminals may be in the form of operating with some steps of the procedure processed in each NF based on NF chains, and each NF may be connected through interfaces as shown in Table 1 above. That is, NFs can configure static connection relationships between NFs. However, there is a need for automatic discovery considering NF discovery and selection operations in large-scale dynamic structures. As an example, the current 5G core network has NRF (network repository function), and NFs can be registered in NRF. NFs can send queries to NRF to request services and select other NFs through responses. Here, as an example, it is difficult to include service discovery and selection logic inside each NF, and considering the above points, SCP (service communication proxy) can be utilized. SCP can perform NF service discovery and selection on behalf, reducing the burden of performing service discovery and selection directly in NFs. However, even when service discovery and selection are performed by SCP, NFs need to be registered and discovered in NRF. That is, service discovery and selection can be performed centrally based on NRF. As an example, centralized service discovery and selection can cause bottlenecks in control plane traffic and delays can occur due to multiple signal discovery procedures, so there may be limitations.

Here, in an environment where service types become diverse and their numbers increase after 5G, a new type of SBA-based core network as described above may be needed, and the SBA-based core network can perform the corresponding functions without the above-mentioned NRF and SCP. As an example, when operating based on an SBA-based core network, the role of selecting appropriate instances of target services within the application context can be performed by service agents and service controllers, and common logic for NF discovery and selection can be included in service agents. That is, all network functions can be connected to service agents that act as proxies performing service requests and responses on behalf, and service agents can perform all service registration/discovery and selection in the signaling logic of network functions.

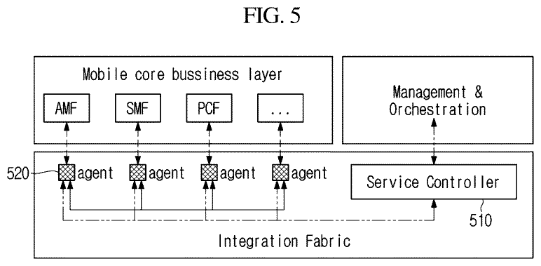

As an example, FIG. 4 is a diagram showing operations between network functions and service controllers according to one embodiment. Referring to FIG. 4, a service controller 400 can control service agents within individual NFs, and each sub-agent within individual NFs can have a proxy role that performs service requests and responses on behalf through mutual connections.

As a more specific example, FIG. 5 is a diagram showing a method of operating based on a service-based interface according to one embodiment. Referring to FIG. 5, in a service based architecture (SBA), the control plane of the 5G core network includes multiple network functions (NFs), and each network function can perform predetermined functions. As an example, the control plane can be composed of a middleware layer of integration fabric to reduce complexity. The integration fabric can be composed of a service controller 510 and an agent 520. Each network function can be performed by directly utilizing an agent 520 within an executable file for service routing. On the other hand, the service controller 510 can collect information about each location and runtime environment parameters of the agent 520 as a service registry role. Additionally, the service controller 510 can define and configure routing functions of agents through interactions with management and orchestration layers. As an example, the integration fabric can provide a unified programming API (application programming interface) through the agent 520 to enable smooth interaction with the business layer composed of core network functions.

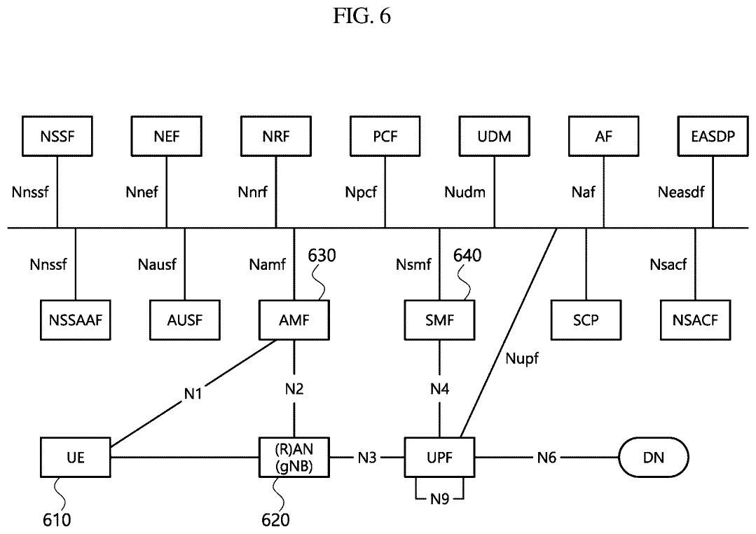

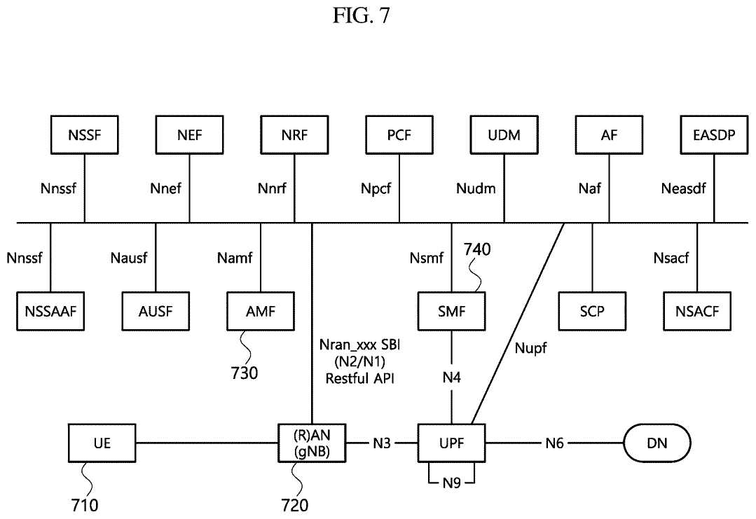

FIG. 6 is a diagram showing a service-based interface based on an SBI structure according to one embodiment. Referring to FIG. 6, all network functions can be configured in a Service Based Interface (SBI) as SBA. As an example, a specific NF can provide services to other authorized NFs and can perform interactions through client-server APIs. That is, existing communication signaling messages can be replaced by API calls of shared service buses, and modularity, scalability, stability, and cost-effectiveness can be improved compared to existing communication systems. As an example, the main change in SBA may be the transition from point-to-point protocols to consumer-producer communication paradigms. That is, in the past, point-to-point protocols required both consumers and producers to establish direct communication channels, so prior knowledge of each other's existence and identifiers may be necessary, which limited scalability. On the other hand, in SBA, service consumers in the consumer-producer or client-server model can find available appropriate network services through service discovery and registration mechanisms and obtain connection information. As an example, the above operation can be implemented by NRF in the 5G core network, but is not limited thereto.

Referring to FIG. 6, NFs can provide or receive communication signal-related messages to other NFs through restful API (application programming interface). In FIG. 6, UE 610 can exchange messages with base station 620, an N1 interface as described above is formed between UE 610 and AMF 630, and an N2 interface can be formed between base station 620 and AMF 630. As an example, in the SBI-based structure of FIG. 6 and the core network structure of FIG. 3, a separate interface may not be formed between base station 620 and SMF 640.

Therefore, when a PDU session is to be established in the network, a session establishment request delivered from UE 610 to base station 620 can be delivered to AMF 630, and AMF 630 can deliver messages necessary for session establishment to other NFs through connected interfaces or SBI-based APIs.

As an example, AMF 630 can select SMF 640 based on the PDU session establishment request obtained from UE 610 and deliver information necessary for PDU session establishment to SMF 640. AMF 630 can deliver a PDU session-SM context creation request to SMF 640 based on the PDU session establishment request and obtain a PDU session-SM context creation response in response. SMF 640 obtains PDU session establishment-related information from AMF 630 and can perform a PCF selection procedure, which will be described later.

FIG. 7 is a diagram showing a structure in which base station functions are connected to SBI based on API according to one embodiment.

Referring to FIG. 7, a base station can be implemented as a software component and may have a structure connected to SBI in the same way as other NFs. Specifically, base station 720 can replace communication-related messages with API calls of shared service buses through restful APIs and can provide services to other NFs or receive services through this. That is, base station 720 can also be implemented as a function based on software components like other NFs. Additionally, base station 720 can also be containerized based on software components and deployed in multiple clouds, and through cloud technology, resources can be shared and services can be dynamically allocated for service operations, but may not be limited thereto. Through the above, modularity, scalability, stability, and cost-effectiveness can be improved compared to existing communication systems, but is not limited thereto. Here, the interface within the API-based SBI of base station 720 may be referred to as “Nran”. However, this is just one example and is not limited to this name and may be referred to by other names. Hereinafter, it is referred to as “Nran” for convenience of description.

As an example, in existing wireless communication systems, base station 720 could deliver NAS (non-access stratum) messages to AMF 730 based on session establishment requests obtained from UE 710, and AMF 730 could perform session establishment by exchanging communication-related messages in the core network, as described above.

However, in new wireless communication systems, base station 720 can provide services to or receive services from other NFs through APIs similar to NFs through SBI. That is, base station 720 can perform direct communication-related message exchange with other NFs through SBI without going through AMF 730. As a specific example, base station 720 can exchange messages related to session establishment through direct communication with SMF 740 without going through AMF 730. In the above situation, communication-related messages between base station 720 and SMF 740 need to be defined, and the following describes a method for performing session establishment considering the above points.

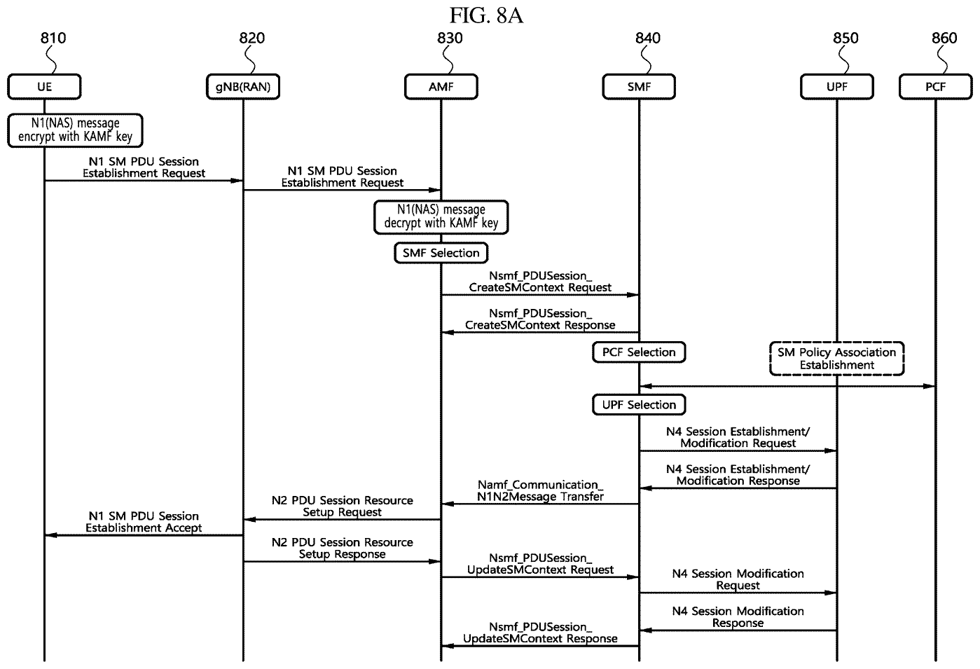

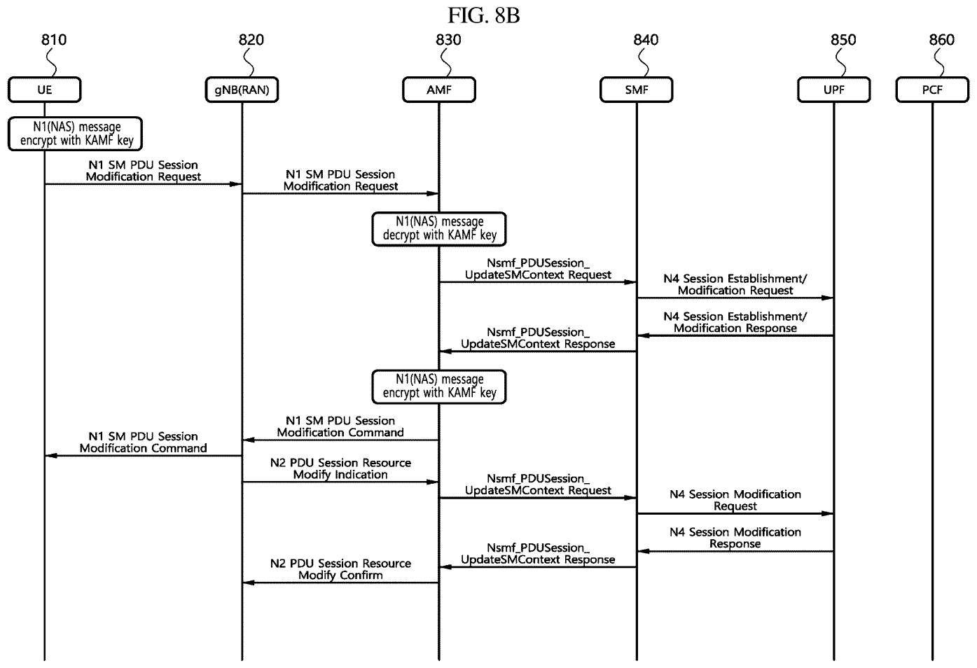

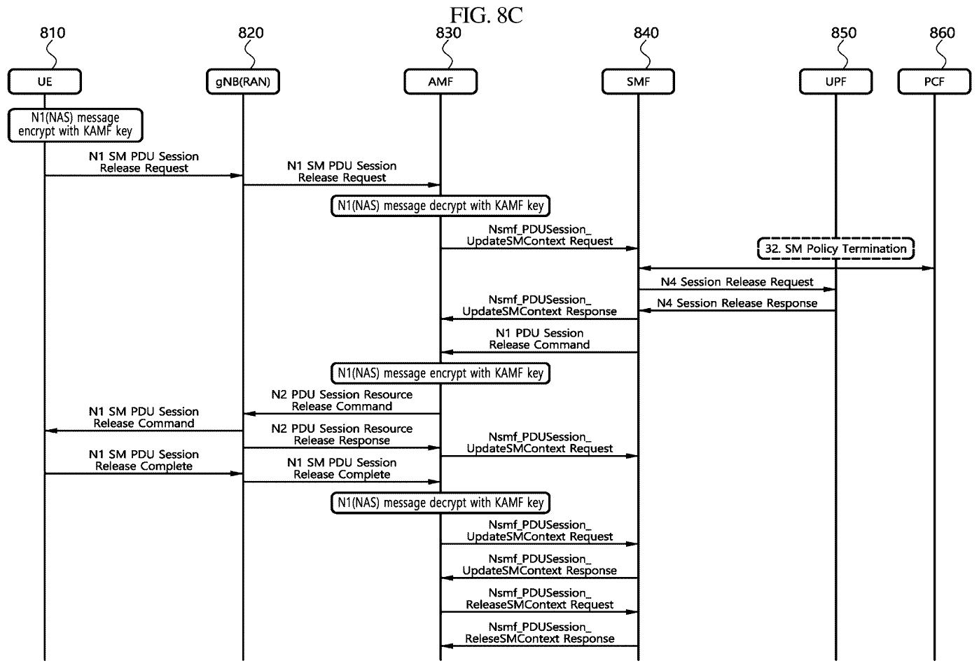

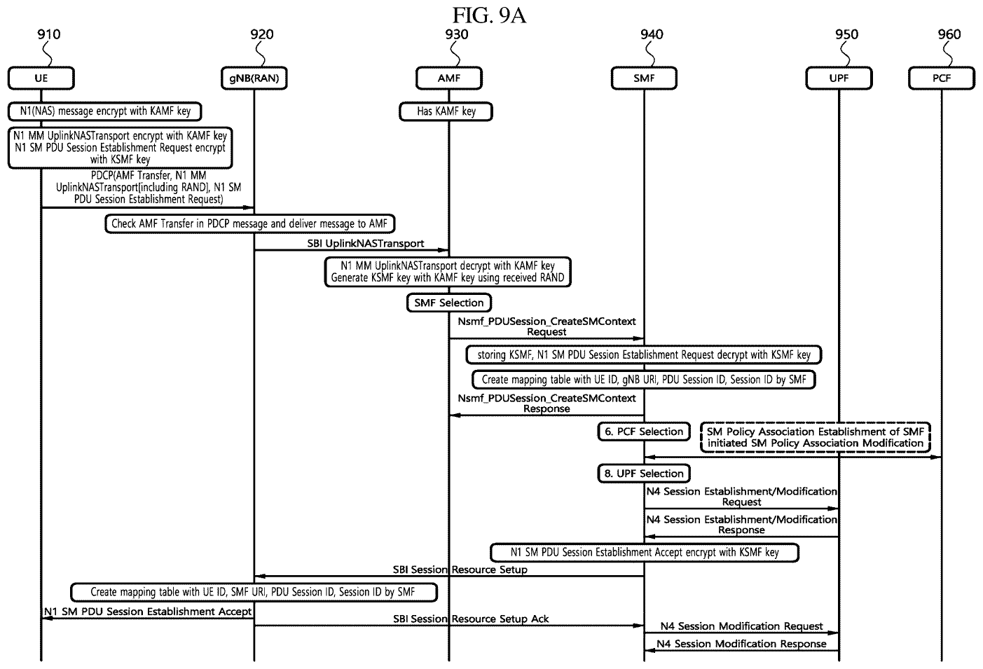

FIGS. 8A to 8C are diagrams showing a method for a terminal to establish, modify, and release a PDU session according to one embodiment.

Referring to FIG. 8A, a PDU (Protocol Data Unit) session for UE can be established in the network. PDU session establishment can be established through at least one of UE 810, RAN 820 (or base station), AMF 830, SMF 840, UPF 850, PCF 860, UDM (not shown), and DN (not shown). Specifically, UE 810 can generate a message for requesting PDU session establishment to base station 820. UE 810 can encrypt an N1 message (NAS) for PDU session request using K_{AMF}key, and the encrypted message can be transmitted to base station 820 as a PDCP (Packet Data Convergence Protocol) message. The PDCP message may include N1 MM uplinkNASTransport and N1 SM PDU Session Establishment Request, and the message may be a NAS message. Then, base station 820 can deliver an N2 (NGAP) uplinkNASTransport message to AMF 830 based on the PDCP message obtained from UE 810. The N2 (NGAP) uplinkNASTransport message may be a message exchanged based on the N2 interface between base station 820 and AMF 830. The message may include N1 MM uplinkNASTransport and N1 SM PDU session establishment request received from UE 810 and can be delivered to AMF 830. AMF 830 can decrypt N1 MM uplinkNASTransport and N1 SM PDU session establishment request in the N2 message obtained from base station 820 through the K_{AMF} key. That is, AMF 830 possesses the K_{AMF} key used by UE 810 and can decrypt N1 MM uplinkNASTransport and N1 SM PDU session establishment request as N1 messages through this to confirm UE 810's PDU session establishment request. As an example, the PDU session establishment request may include PDU session type, DN information, and other information, but is not limited to a specific form.

Then, AMF 830 performs SMF 840 selection procedure and can deliver a PDU session-related SM context creation (Nsmf_PDUSession_CreateSMContext Request) request to the selected SMF 840 and receive a response (Nsmf_PDUSession_CreateSMContext Response). AMF 830 can exchange the above messages through an interface (e.g. N11) or SBI between AMF 830 and SMF 840, but is not limited thereto. The PDU session-related SM context creation (Nsmf_PDUSession_CreateSMContext Request) request may include information that AMF 830 obtained through PDU session request from UE 810. Then, SMF 840 can perform PCF 860 selection procedure, and SM policy association establishment can be performed based on the selected PCF 860. The SM policy association establishment request may include context information such as SUPI (subscription permanent identifier), DNN (data network name), and NSSAI (network slice selection assistance information), but is not limited thereto. PCF 860 can determine policies corresponding to SUPI along with PCC rules by querying local configuration or subscriber profiles stored in UDR. SMF 840 obtains the determined policies and PCC rules from PCF 860 and can select one or more UPFs 850 based on this. As an example, SMF can check cell ID information or TAC (tracking area code) information as user location information when selecting an appropriate UPF. Then, SMF 840 can select and configure UPF based on the N4 interface and instruct how to route traffic between the terminal and data network.

As an example, SMF 840 selects UPF 850, delivers a session establishment/modification request (N4 Session Establishment/Modification Request) to UPF 850, and can establish a PDU session by obtaining a response (N4 Session Establishment/Modification Response). Then, SMF 840 can deliver a message (Namf_Communication_N1N2MessageTransfer) to AMF 830, and the message may include N2 SM information (N2 SM Info) and N1 PDU Session Establishment Accept. Here, the N2 SM information may include PDU session resource setup request transfer (PDUSessionResourceSetupRequestTransfer) and PDU session ID information. AMF 830 can deliver a PDU session resource setup request (N2 PDU Session Resource Setup Request) to base station 820 based on the message obtained from SMF 840. Here, the PDU session resource setup request may include N2 SM information, PDU session ID, N1 MM DownlinkNASTransport, and N1 PDU Session Establishment Accept. Base station 820 can deliver a PDCP message including N1 MM DownlinkNASTransport and N1 PDU session establishment accept information to UE 810 based on the PDU session resource setup request obtained from AMF 830. Additionally, base station 820 can deliver a PDU session resource setup response (N2 PDU Session Resource setup response) including N2 SM information to AMF 830. The N2 SM information may include PDU session resource setup response transfer (PDUSessionResourceSetupResponseTransfer) and PDU session ID information. AMF 830 can deliver a PDU session-related SM context update request (Nsmf_PDU Session_Update SM Context Request) to SMF 840 based on the PDU session resource setup response obtained from base station 820. Here, the PDU session-related SM context update request may include the above-mentioned N2 SM information. SMF 840 can deliver a session modification request (N4 session modification request) to UPF 850 based on information obtained from AMF 830 and obtain a response (N4 session modification response). Then, SMF 840 can deliver a PDU session-related SM context update response (Nsmf_PDU Session_Update SM Context Response) to AMF 830, and through this, a PDU session can be established. That is, PDU session establishment can be performed through the interface between AMF 830 and SMF 840 based on information that AMF 830 obtained from base station 820.

Referring to FIG. 8B, a PDU (Protocol Data Unit) session modification procedure can be performed in the network. PDU session modification can be established based on at least one of UE 810, RAN 820 (or base station), AMF 830, SMF 840, UPF 850, PCF 860, UDM (not shown), and DN (not shown). Specifically, referring to FIG. 8B, UE 810 can encrypt an N1 message for requesting PDU session modification to base station 820. UE 810 can encrypt N1 MM UplinkNASTransport and PDU session modification request (N1 SM PDU Session Modification Request) as N1 message (NAS) using K_{AMF} key. UE 810 can transmit a PDCP message including N1 MM UplinkNASTransport and PDU session modification request to base station 820. Base station 820 can deliver an N2 (NGAP) uplinkNASTransport message to AMF 830 through the N2 interface. The N2 (NGAP) uplinkNASTransport message may include N1 MM uplinkNASTransport and N1 SM PDU session modification request. AMF 830 possesses the K_{AMF}key used by UE 810 and can decrypt N1 MM uplinkNASTransport and N1 SM PDU session modification request through this to confirm UE 810's PDU session establishment request. As an example, the PDU session establishment request may include PDU session type, DN information, and other information, but is not limited to a specific form.

Then, AMF 830 can deliver a PDU session-related SM context update (Nsmf_PDU Session_Update SM Context Request) request to SMF 840. As an example, the PDU session-related SM context update request (Nsmf_PDU Session_Update SM Context Request) may include information that AMF 830 obtained through PDU session request from UE 810. Then, SMF 840 delivers a session establishment/modification request (N4 Session Establishment/Modification Request) to UPF 850 and can modify the PDU session by obtaining a response (N4 Session Establishment/Modification Response). Then, SMF 840 can deliver a PDU session-related SM context update response (Nsmf_PDU Session_Update SM Context Response) to AMF 830.

AMF 830 encrypts a NAS message including N1 MM DownlinkNASTransport and N1 PDU session modification command (N1 SM PDU Session Modification Command) using K_{AMF} key based on information obtained from SMF 840 and can deliver an N2 message (N2 DownlinkNASTransport) including N1 MM DownlinkNASTransport and N1 PDU session modification command to base station 820.

Base station 820 can deliver a PDCP message including N1 MM DownlinkNASTransport and N1 PDU session modification command to UE 810 based on information obtained from AMF 830. Additionally, base station 820 can deliver a PDU session resource modification indication (N2 PDU Session Resource Modify indication) including N2 SM information to AMF 830. The N2 SM information may include PDU session resource modification indication (PDU Session Resource Modify Indication Transfer) and PDU session ID information. AMF 830 can deliver a PDU session-related SM context update request (Nsmf_PDU Session_Update SM Context Request) to SMF 840 based on the PDU session resource setup modification indication obtained from base station 820. Here, the SM context update request may include the above-mentioned N2 SM information. SMF 840 can deliver a session modification request (N4 session modification request) to UPF 850 based on information obtained from AMF 830 and obtain a response (N4 session modification response). Then, SMF 840 can deliver a PDU session-related SM context update response (Nsmf_PDUSession_Update SM Context Response) to AMF 830. Then, AMF 830 can deliver a PDU session resource modification confirm transfer (N2 PDU Session Resource Modify Confirm Transfer) to base station 820. Here, the PDU session resource modification confirm transfer may include N2 SM information, and the N2 SM information may include PDU session resource modification confirm transfer (PDU Session Resource Modify Confirm Transfer) and PDU session ID. That is, PDU session modification can be performed through the interface between AMF 830 and SMF 840 based on information that AMF 830 obtained from base station 820. Here, AMF 830 and SMF 840 can be connected through N11 interface or the above-mentioned SBI structure and are not limited to a specific form.

Referring to FIG. 8C, a PDU session established in the network can be released. PDU session release can be established based on at least one of UE 810, RAN 820 (or base station), AMF 830, SMF 840, UPF 850, PCF 860, UDM (not shown), and DN (not shown). Specifically, UE 810 can encrypt N1 MM uplinkNASTransport and N1 SM PDU session establishment request as N1 message (NAS) using K_{AMF}key to request PDU session release to base station 820. UE 810 can transmit a PDCP message including encrypted N1 MM uplinkNASTransport and N1 SM PDU session establishment request to base station 820. Base station 820 can deliver an N2 (NGAP) uplinkNASTransport message to AMF 830 as an N2 message, and the N2 (NGAP) uplinkNASTransport message may include N1 MM uplinkNASTransport and N1 SM PDU session release request. AMF 830 possesses the K_{AMF} key used by UE 810 and can decrypt N1 MM uplinkNASTransport and N1 SM PDU session release request included in the N2 (NGAP) uplinkNASTransport message through this to confirm UE 810's PDU session release request. As an example, the PDU session release request may include PDU session type, DN information, and other information, but is not limited to a specific form.

AMF 830 can deliver a PDU session-related SM context update request (Nsmf_PDUSession_Update SM Context Request) to SMF 840. Here, the PDU session-related SM context update request may include N1 SM PDU Session Release Request. Then, SMF 840 can perform SM Policy Termination procedure with PCF 860. Then, SMF 840 delivers a session release request (N4 Session Release Request) to UPF 850 and can release the PDU session by obtaining a response (N4 Session Release Response). Then, SMF 840 can deliver a PDU session-related SM context update response (Nsmf_PDU Session_Update SM Context Response) to AMF 830. Additionally, SMF 840 can deliver a message (Namf_Communication NIN2MessageTransfer) to AMF 830, and the message may include N2 SM information (N2 SM Info) and N1 PDU session release command transfer (N1 PDU Session Release Command Transfer). Here, the N2 SM information may include PDU session resource release command (PDU Session Resource Release Command) and PDU session ID information. AMF 830 can encrypt an N1 message (NAS) including N1 MM DownlinkNASTransport and N1 SM PDU session release command (N1 SM PDU Session Release Command) using K_{AMF} key. AMF 830 can deliver a PDU session resource release command (N2 PDU Session Resource Release Command) to base station 820 based on the message obtained from SMF 840. Here, the PDU session resource release command may include N2 SM information, encrypted N1 MM DownlinkNASTransport, and N1 PDU Session Release Command. The N2 SM information may include PDU session resource release command transfer (PDU Session Resource Release Command Transfer) and PDU session ID. Then, base station 820 can deliver a PDCP message including N1 MM DownlinkNASTransport and N1 PDU session release command to UE 810 based on the PDU session resource setup request obtained from AMF 830. Additionally, base station 820 can deliver a PDU session resource release response (N2 PDU Session Resource Release Response) including N2 SM information to AMF 830. The N2 SM information may include PDU session resource release response transfer (PDU Session Resource Release Response Transfer) and PDU session ID information. AMF 830 can deliver a PDU session-related SM context update request (Nsmf_PDU Session_Update SM Context Request) to SMF 840 based on the PDU session resource setup response obtained from base station 820. Here, the SM context update request may include the above-mentioned N2 SM information.

Additionally, base station 820 obtains a PDCP message including N1 MM uplinkNASTransport and N1 SM PDU session release complete (N1 SM PDU Session Release Complete) encrypted through K_{AMF} from terminal 810 and can deliver an N2 uplinkNASTransport message including encrypted N1 MM uplinkNASTransport and N1 SM PDU session release complete to AMF 830. AMF 830 decrypts NIMM uplinkNASTransport and N1 SM PDU session release complete in the N2 uplinkNASTransport message using K_{AMF} key and can confirm PDU session release completion information. Then, AMF can deliver a PDU session-related SM context update request (Nsmf_PDU Session_Update SM Context Request) including N1 SM PDU Session Release Complete to SMF 840 and obtain a response (Nsmf_PDU Session_Update SM Context Response). Then, AMF 830 can deliver a PDU session-related SM context release request (Nsmf_PDU Session Release SM Context Request) to SMF 840 and obtain a response (Nsmf_PDU Session Release SM Context Response). Through this, a PDU session can be released. That is, PDU session release can be performed through the interface between AMF 830 and SMF 840 based on information that AMF 830 obtained from base station 820. Here, AMF 830 and SMF 840 can be connected through N11 interface or the above-mentioned SBI structure and are not limited to a specific form.

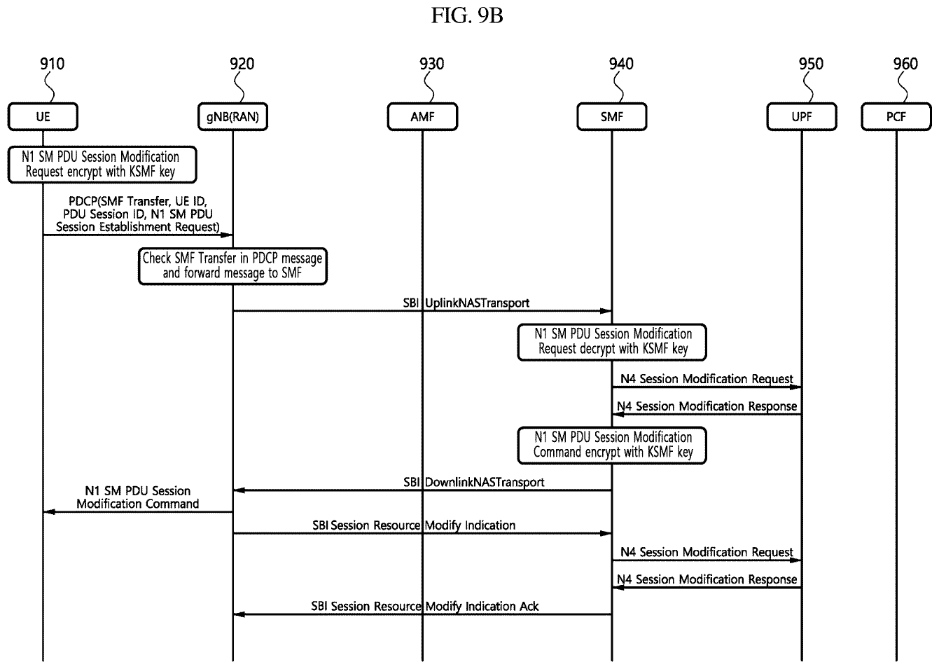

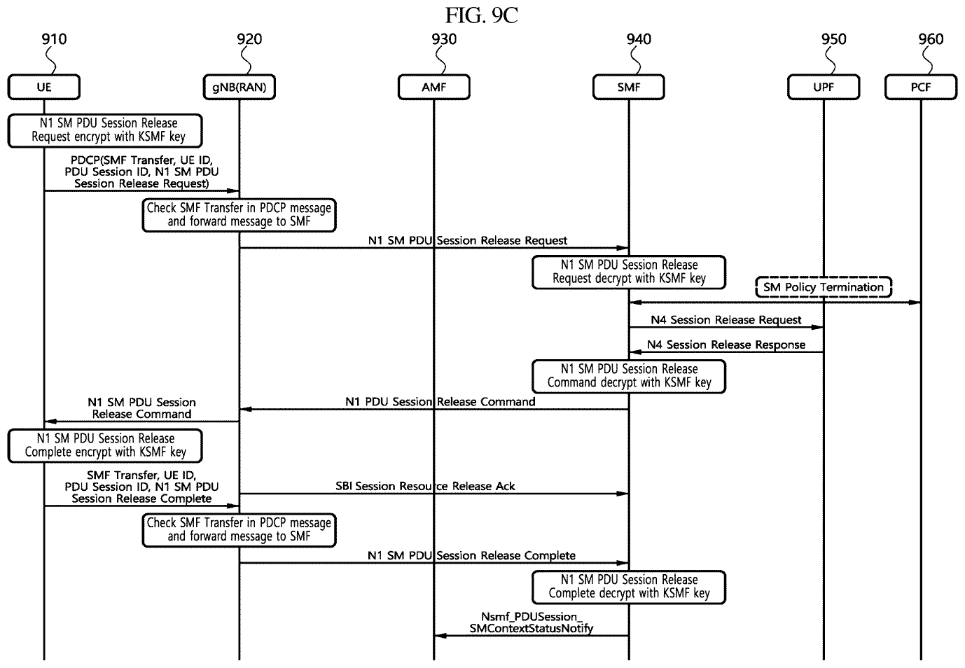

FIGS. 9A to 9C are diagrams showing a method for a terminal to establish, modify, and release a PDU session according to one embodiment.

Referring to FIG. 9A, a PDU session can be established in the network. Here, RAN 920 (or base station) can provide services to or receive services from other NFs through APIs in SBI based on FIG. 7 described above. As an example, base station 920 can be virtualized based on software structure and can perform common service bus-based operations in SBI. Therefore, base station 920 can exchange communication-related messages with other NFs as well as AMF 930. That is, base station 920 can perform communication-related message exchange with other NFs without going through AMF 930.

Based on the above, base station 920 can directly exchange communication-related messages with SMF 940. Here, when PDU sessions for terminals are established, modified, and released in the network, base station 920 and SMF 940 can directly exchange messages, so procedures different from FIGS. 8A to 8C described above can be performed, which can reduce complexity of session establishment and enable efficient session establishment.

As a specific example, referring to FIG. 9A, UE 910 and AMF 930 can possess the same K_{AMF} key as described above, and accordingly, messages encrypted through K_{AMF} key in UE 910 can be decrypted in AMF 930. Here, UE 910 can further possess a K_{SMF} key. As an example, the K_{SMF} key can be generated based on K_{AMF}, key and random number (RAND number). More specifically, the K_{SMF}key can be generated through Key Derivation Function (KDF) of Equation 1 below based on K_{AMF} and random number, but may not be limited thereto.

$${K}_{SMF} = KDF ( {K}_{AMF} , RAND ) \qquad [ Equation 1 ]$$

As another example, K_{SMF} can be generated through other keys without using K_{AMF} key.

UE 910 can encrypt N1 MM uplinkNASTransport using K_{AMF} and encrypt N1 SM PDU establishment request (N1 SM PDU Session Establishment Request) using K_{SMF} key. UE 910 can deliver a PDCP message including AMF transfer, N1 MM uplinkNASTransport encrypted using K_{AMF}, and N1 SM PDU establishment request encrypted using K_{SMF} key to base station 920. Here, N1 MM uplinkNASTransport may include random number (RAND) value used to generate K_{SMF} key. Base station 920 confirms AMF transfer in the PDCP message and can deliver a message including N1 MM uplinkNASTransport and N1 SM PDU establishment request to AMF 930. As an example, the message that base station 920 delivers to AMF 930 may be an SBI-based message. That is, base station 920 can directly exchange communication-related messages with AMF 930 through SBI, but may not be limited to this embodiment. Then, AMF 930 can decrypt N1 MM UplinkNASTransport using K_{AMF}. N1 MM UplinkNASTransport may include random number value used to generate K_{SMF}, and AMF 930 can obtain the random number value through N1 MM UplinkNASTransport decryption. AMF 930 can generate K_{SMF} using the obtained random number value and K_{AMF}. As an example, AMF 930 can also generate K_{SMF} based on Equation 1 described above, and accordingly, the same key as the K_{SMF} key generated in UE 910 can be generated.

AMF 930 performs SMF selection and can deliver a PDU session-related SM context creation request (Nsmf_PDU Session Create SM Context Request) to the selected SMF 940. The PDU session-related SM context creation request may include at least one of base station URI (Uniform Resource Identifier, e.g. qNB URI), UE ID, K_{SMF}, cyphering algorithm (cypheringAlg), integrity algorithm (integrityAlg), and N1 SM PDU session establishment request (Session Establishment Request). As an example, since SMF 940 and base station 920 can directly exchange communication-related messages based on SBI, the PDU session-related SM context creation request may include base station URI, but is not limited to this embodiment.

Then, SMF 940 stores the received K_{SMF} key and can decrypt the received N1 SM PDU session establishment request through K_{SMF} key. Additionally, SMF 940 can create a mapping table based on UE ID, base station URI, PDU session ID, and session ID generated by SMF. Then, SMF 940 can deliver a PDU session-related SM context response (Nsmf_PDU Session Create SM Context Response) to AMF 930. Then, SMF 940 can perform PCF 960 selection procedure, and SM policy association establishment can be performed based on the selected PCF 960. Then, SMF 940 selects UPF 950, delivers a session establishment/modification request (N4 Session Establishment/Modification Request) to UPF 950, and can establish a PDU session by obtaining a response (N4 Session Establishment/Modification Response). Then, SMF 940 can encrypt an N1 SM PDU session establishment accept (N1 SM PDU Session Establishment Accept) message using K_{SMF} key. Here, SMF 940 can directly deliver session resource setup (Session Resource Setup) to base station 920. As an example, since base station 920 and SMF 940 can be directly connected based on SBI structure, session resource setup can be directly delivered to base station 920. Here, session resource setup may include at least one of N2 SM information, N1 PDU session establishment accept, SMF URI, and session ID by SMF. Additionally, N2 SM information may include at least one of PDU session resource setup request transfer (PDU Session Resource Setup Request Transfer) and PDU session ID. Base station 920 can create a mapping table based on obtained information such as UE ID, SMF URI, PDU session ID, and session ID by SMF. As an example, since base station 920 can directly exchange communication-related messages with SMF 940 based on SBI, SMF URI information may be necessary, but is not limited thereto. Then, base station 920 can deliver a PDCP message including N1 SM PDU session establishment accept (N1 SM PDU Session Establishment Accept) to UE 910.

Additionally, base station 920 can directly deliver session resource setup acknowledgment (Session Resource Setup Ack) to SMF 940. As an example, since base station 920 and SMF 940 can be directly connected based on SBI structure, session resource setup acknowledgment can be directly delivered to SMF 940. Session resource setup acknowledgment may include N2 SM information, and N2 SM information may include PDU session resource setup request transfer (PDU Session Resource Setup Request Transfer) and PDU session ID. Then, SMF 940 can deliver a session modification request (N4 session modification request) to UPF 950 based on obtained information and obtain a response (N4 session modification response). That is, in the PDU session establishment process, base station 920 and SMF 940 can directly exchange messages based on SBI structure.

Referring to FIG. 9B, a PDU session can be modified in the network. Here, since UE 910 possesses K_{SMF} key, it can encrypt N1 SM PDU session modification request (N1 SM PDU Session Modification Request) using K_{SMF} key without encrypting it as N1 MM UplinkNASTransport. Then, UE 910 can deliver a PDCP message including SMF Transfer, UE ID, PDU session ID, and N1 SM PDU session modification request to base station 920. Base station 920 confirms SMF Transfer in the PDCP message and can directly deliver UplinkNASTransport including N1 SM PDU session modification request to SMF 940. Since SMF 940 also possesses the above-mentioned K_{SMF} key, it can decrypt the obtained N1 SM PDU session modification request using this. Then, SMF 940 selects UPF 950, delivers a session establishment/modification request (N4 Session Establishment/Modification Request) to UPF 950, and can modify the PDU session by obtaining a response (N4 Session Establishment/Modification Response). Then, SMF 940 can encrypt an N1 SM PDU session modification command (N1 SM PDU Session Modification Command) message using K_{SMF} key. SMF 940 can directly deliver DownlinkNASTransport including N1 SM PDU session modification command to base station 920. As an example, since base station 920 and SMF 940 can directly exchange communication-related messages based on SBI structure, DownlinkNASTransport can be directly delivered to base station 920. Base station 920 can deliver a PDCP message including N1 SM PDU session modification command to UE 910.

Additionally, base station 920 can directly deliver session resource modification indication (Session Resource Modify Indication) to SMF 940. Here, session resource modification indication may include N2 SM information, and N2 SM information may include PDU session resource modification indication transfer (PDU Session Resource Modify Indication Transfer) and PDU session ID. Then, SMF 940 can deliver a session modification request (N4 session modification request) to UPF 950 based on obtained information and obtain a response (N4 session modification response). Then, SMF 940 can directly deliver session resource modification indication acknowledgment (Session Resource Modify Indication Ack) to base station 920.

Since base station 920 and SMF 940 can directly exchange communication-related messages based on SBI, session resource modification indication acknowledgment can be directly delivered to base station 920. Session resource modification indication acknowledgment may include N2 SM information, and N2 SM information may include PDU session resource modification confirm transfer (PDU Session Resource Modify Confirm Transfer) and PDU session ID. That is, in the PDU session modification process, base station 920 and SMF 940 can directly exchange communication-related messages based on SBI.

Referring to FIG. 9C, a PDU session can be released in the network. UE 910 can encrypt N1 SM PDU session release request (N1 SM PDU Session Release Request) using K_{SMF} key for messages to be delivered to SMF. Then, UE 910 can deliver a PDCP message including SMF Transfer, UE ID, PDU session ID, and N1 SM PDU session release request to base station 920. Base station 920 confirms SMF Transfer in the PDCP message and can directly deliver UplinkNASTransport including N1 SM PDU session release request to SMF 940. Since SMF 940 also possesses the above-mentioned K_{SMF}key, it can decrypt the obtained N1 SM PDU session release request using this. Then, SMF 940 can perform SM policy termination procedure with PCF 960. Additionally, SMF 940 delivers a session release request (N4 Session Release Request) to UPF 950 and can release the PDU session by obtaining a response (N4 Session Release Response). Then, SMF 940 can encrypt an N1 SM PDU session release command (N1 SM PDU Session Release Command) message using K_{SMF}key. SMF 940 can directly deliver session resource release (Session Resource Release) to base station 920. Session resource release may include N2 SM information and N1 PDU Session Release Command. Additionally, N2 information may include PDU session resource release command transfer (PDU Session Resource Release Command Transfer) and PDU session ID information. Base station 920 can deliver a PDCP message including N1 SM PDU session release command to UE 910. Additionally, base station 920 can directly deliver session resource release indication (Session Resource Release Ack) to SMF 940. Here, session resource release indication may include N2 SM information, and N2 SM information may include PDU session resource release response transfer (PDU Session Resource Release Response Transfer) and PDU session ID.

UE 910 can decrypt N1 SM PDU session release command in the received PDCP message using K_{SMF} key. Then, UE 910 completes PDU session release and can encrypt N1 SM session release complete (N1 SM PDU Session Release Complete) using K_{SMF} key. UE 910 can deliver a PDCP message including SMF Transfer, UE ID, PDU session ID, and N1 SM session release complete to base station 920, and base station 920 can confirm SMF Transfer in the PDCP message and forward the information to SMF 940. Base station 920 can directly deliver UplinkNASTrasport including N1 SM PDU session release complete to SMF 940 based on the PDCP message. SMF 940 can decrypt N1 SM PDU session release complete using K_{SMF}key to recognize that PDU session release is completed. Then, SMF 940 can deliver PDU session-related SM context status indication (Nsmf_PDU Session_SM Context Status Notify) to AMF 930. As an example, PDU session release can be recognized by base station 920 and SMF 940 based on the above, but AMF 930 may not recognize PDU session release. Considering the above points, SMF 940 can deliver PDU session-related SM context status indication to AMF 930. As an example, PDU session-related SM context status indication may include information indicating that session is released and PDU session ID information, but is not limited to this embodiment.

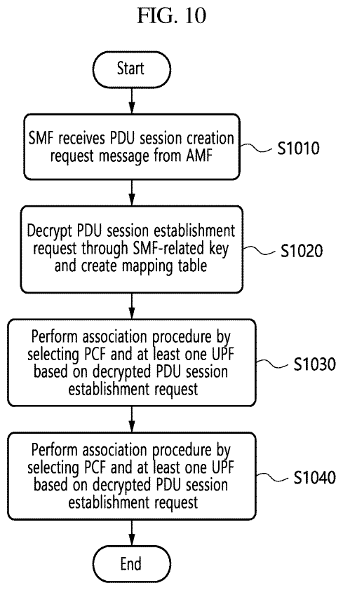

FIG. 10 is a flowchart showing a method for an SMF to establish a PDU session according to one embodiment. Referring to FIG. 10, SMF can receive a PDU session creation request message from AMF (S1010). Here, the PDU session creation request message may include SMF-related key and PDU session establishment request. As an example, the SMF-related key may be the above-mentioned K_{SMF}. Then, SMF can decrypt the PDU session establishment request through the SMF-related key and generate a mapping table (S1020). As an example, the mapping table may include at least one of UE ID, base station URI, PDU session ID, and session ID by SMF, as described above.

Then, SMF can perform association procedure by selecting PCF and at least one UPF based on the decrypted PDU session establishment request (S1030). When PDU session establishment is completed, SMF can encrypt PDU session establishment accept through the SMF-related key and directly transmit PDU session resource setup including PDU session establishment accept to the base station (S1040).

As an example, SMF may be an apparatus for establishing PDU sessions including a memory storing at least one program, a transceiver for transmitting and receiving at least one signal, and a processor executing at least one program stored in the memory, and can perform the above operations. Here, each of at least one NFs and the base station can directly exchange communication-related messages based on SBI. As an example, each of the at least one NFs and the base station is virtualized as software configuration, and each of the at least one NFs and the base station can directly exchange communication-related messages in SBI through API, as described above.

Additionally, UE and AMF can possess AMF-related key. UE can generate SMF-related key based on AMF-related key and random number value. UE can deliver a PDCP message including message encrypted through AMF-related key and PDU session creation request encrypted through SMF-related key to the base station. Here, the message encrypted through AMF-related key includes random number value, and the base station can deliver a message including message encrypted through AMF-related key and PDU session creation request encrypted through SMF-related key to AMF. AMF decrypts the message encrypted through AMF-related key using AMF-related key to obtain random number value, and can generate SMF-related key through number value and possessed AMF-related key. AMF can deliver generated SMF-related key and PDU session creation request encrypted through SMF-related key to SMF, as described above. SMF can decrypt PDU session establishment request encrypted through SMF-related key using received SMF-related key.

Additionally, as an example, when established PDU session is modified, SMF receives PDU session modification request encrypted through SMF-related key, decrypts it using SMF-related key, performs PDU session modification procedure with at least one UPFs based on decrypted PDU session modification request, and can encrypt PDU session modification command through SMF-related key and directly deliver it to the base station. Here, UE encrypts PDU session modification request through SMF-related key and can deliver a PDCP message including encrypted PDU session modification request to the base station. The base station can directly deliver PDU session modification request encrypted through SMF-related key to SMF based on SBI, as described above.

Additionally, as an example, when established PDU session is released, SMF receives PDU session release request encrypted through SMF-related key and can decrypt it using SMF-related key. Then, it performs PDU session release procedure with PCF and at least one UPFs based on PDU session release request and can encrypt PDU session release command through SMF-related key and directly deliver it to the base station. Here, UE encrypts PDU session release request through SMF-related key and can deliver a PDCP message including encrypted PDU session release request to the base station. The base station can directly deliver PDU session modification request encrypted through SMF-related key to SMF based on SBI, as described above. The base station delivers PDU session release command encrypted through SMF-related key to UE, and UE decrypts and confirms PDU session release command through SMF-related key and can encrypt PDU session release complete through SMF-related key. UE delivers a PDCP message including encrypted PDU session release complete to the base station, and the base station can directly deliver PDU session release complete encrypted through SMF-related key to SMF. SMF can decrypt PDU session release complete encrypted through SMF-related key using SMF-related key. Additionally, as an example, SMF can indicate PDU session release completion to AMF.

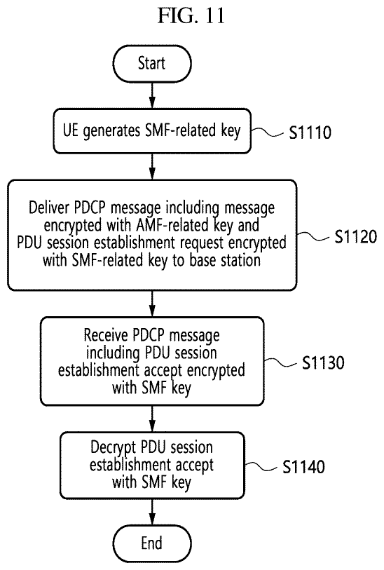

FIG. 11 is a flowchart showing a method for an SMF to establish a PDU session according to one embodiment. Referring to FIG. 11, UE can generate SMF-related key (S1110). Here, the SMF-related key may be the above-mentioned K_{SMF}. As an example, UE can generate SMF-related key based on AMF-related key and random number value. Then, UE can deliver a PDCP message including message encrypted through AMF-related key and PDU session establishment request encrypted through SMF-related key to the base station (S1120). Here, the message encrypted through AMF-related key may include random number value. Then, UE can receive a PDCP message including PDU session establishment accept encrypted through SMF key (S1130) and decrypt PDU session establishment accept through SMF key (S1140). As an example, UE may be an apparatus for establishing PDU sessions including a memory storing at least one program, a transceiver for transmitting and receiving at least one signal, and a processor executing at least one program stored in the memory, and can perform the above operations based on this.

Here, as an example, the base station can deliver a message including message encrypted through AMF-related key and PDU session establishment request encrypted through SMF-related key to AMF based on SBI, as described above. Additionally, the base station can directly obtain a message including PDU session establishment accept encrypted through SMF key from SMF based on SBI, as described above.

Additionally, when the established PDU session is modified, UE encrypts PDU session modification request through SMF-related key and delivers it to the base station, and the base station can directly deliver a message including PDU session modification request encrypted through SMF-related key to SMF. The base station can receive a message including PDU session modification command encrypted through SMF key from SMF and deliver PDU session modification command to UE.

Additionally, when the established PDU session is released, UE encrypts PDU session release request through SMF-related key and delivers it to the base station, and the base station can directly deliver a message including PDU session release request encrypted through SMF-related key to SMF. Then, the base station can receive a message including PDU session release command encrypted through SMF key from SMF and deliver PDU session release command to UE.

Meanwhile, embodiments of the present invention are not implemented only through the apparatus and/or method described so far, but may also be implemented through a program that realizes functions corresponding to the configurations of embodiments of the present invention or a recording medium on which the program is recorded, and such implementation can be easily implemented by those skilled in the art from the description of the above embodiments. Specifically, methods according to embodiments of the present invention (e.g., network management method, data transmission method, transmission schedule generation method, etc.) may be implemented in the form of program instructions that can be executed through various computer means and recorded on computer-readable media. The computer-readable media may include program instructions, data files, data structures, etc. alone or in combination. The program instructions recorded on the computer-readable media may be specially designed and configured for embodiments of the present invention, or may be known and available to those skilled in the field of computer software. Computer-readable recording media may include hardware devices configured to store and execute program instructions. For example, computer-readable recording media may be magnetic media such as hard disks, floppy disks, and magnetic tapes, optical media such as CD-ROMs and DVDs, magneto-optical media such as floptical disks, ROM, RAM, flash memory, etc. Program instructions may include not only machine language code created by compilers but also high-level language code that can be executed by computers through interpreters.

Although embodiments of the present invention have been described in detail above, the scope of the present invention is not limited thereto, and various modifications and improvements by those skilled in the art using the basic concepts of the present invention defined in the following claims also belong to the scope of the present invention.

What is claimed is:

1. A method for establishing a PDU (protocol data unit) session, the method comprising:
receiving, by an SMF (session management function), a PDU session creation request message from an AMF (access management function), wherein the PDU session creation request message includes an SMF-related key and a PDU session establishment request;
decrypting, by the SMF, the PDU session establishment request through the SMF-related key and generating a mapping table;
performing an association procedure by selecting a PCF (policy control function) and at least one UPF (user plane function) based on the decrypted PDU session establishment request; and
encrypting a PDU session establishment accept through the SMF-related key and transmitting a PDU session resource setup including the PDU session establishment accept to a base station.

2. The method of claim 1, wherein each of at least one network function (NF) and the base station directly exchanges communication-related messages based on a service based interface (SBI).

3. The method of claim 2, wherein each of the at least one NFs and the base station is virtualized as a software configuration, and each of the at least one NFs and the base station directly exchanges the communication-related messages in the SBI through an API (application programming interface).

4. The method of claim 1, wherein a user equipment (UE) and the AMF possess an AMF-related key, the SMF-related key is generated by the UE based on the AMF-related key and a random number value,
a message encrypted through the AMF-related key and a PDU session creation request encrypted through the SMF-related key are included in a PDCP (packet data convergence protocol) message and delivered to the base station, the message encrypted through the AMF-related key includes the random number value,
the base station delivers a message including the message encrypted through the AMF-related key and the PDU session creation request encrypted through the SMF-related key to the AMF,
the AMF decrypts the message encrypted through the AMF-related key using the AMF-related key to obtain the random number value,
generates the SMF-related key through the random number value and the possessed AMF-related key, and delivers the generated SMF-related key and the PDU session creation request encrypted through the SMF-related key to the SMF.

5. The method of claim 4, wherein the SMF decrypts the PDU session establishment request encrypted through the SMF-related key using the received SMF-related key.

6. The method of claim 2, wherein when the established PDU session is modified, the SMF receives a PDU session modification request encrypted through the SMF-related key, decrypts the PDU session modification request using the SMF-related key, performs a PDU session modification procedure with the at least one UPFs based on the decrypted PDU session modification request, and encrypts a PDU session modification command through the SMF-related key and directly delivers the PDU session modification command to the base station.

7. The method of claim 6, wherein the UE encrypts the PDU session modification request through the SMF-related key, delivers a PDCP message including the encrypted PDU session modification request to the base station, and the base station directly delivers the PDU session modification request encrypted through the SMF-related key to the SMF based on the SBI.

8. The method of claim 2, wherein when the established PDU session is released, the SMF receives a PDU session release request encrypted through the SMF-related key, decrypts the PDU session release request using the SMF-related key, performs a PDU session release procedure with the PCF and the at least one UPFs based on the PDU session release request, and encrypts a PDU session release command through the SMF-related key and directly delivers the PDU session release command to the base station.

9. The method of claim 8, wherein the UE encrypts the PDU session release request through the SMF-related key, delivers a PDCP message including the encrypted PDU session release request to the base station, and the base station directly delivers the PDU session modification request encrypted through the SMF-related key to the SMF based on the SBI.

10. The method of claim 8, wherein the base station delivers the PDU session release command encrypted through the SMF-related key to the UE,
the UE decrypts and confirms the PDU session release command through the SMF-related key,
encrypts a PDU session release complete through the SMF-related key, delivers a PDCP message including the encrypted PDU session release complete to the base station,
the base station directly delivers the PDU session release complete encrypted through the SMF-related key to the SMF, and
the SMF decrypts the PDU session release complete encrypted through the SMF-related key using the SMF-related key.

11. The method of claim 10, wherein the SMF indicates PDU session release completion to the AMF.

12. An apparatus for establishing a PDU session, the apparatus comprising:
a memory storing at least one program;
a transceiver for transmitting and receiving at least one signal; and
a processor executing at least one program stored in the memory,
wherein the processor:
receives a PDU session creation request message from an AMF (access management function), wherein the PDU session creation request message includes an SMF-related key and a PDU session establishment request,
decrypts the PDU session establishment request through the SMF-related key and generates a mapping table,
performs an association procedure by selecting a PCF (policy control function) and at least one UPF (user plane function) based on the decrypted PDU session establishment request, and
encrypts a PDU session establishment accept through the SMF-related key and transmits a PDU session resource setup including the PDU session establishment accept to a base station.

13. A method for establishing a PDU (protocol data unit) session, the method comprising:
generating, by a user equipment (UE), an SMF (session management function)-related key, wherein the UE generates the SMF-related key based on an AMF-related key and a random number value;
delivering a PDCP (packet data convergence protocol) message including a message encrypted through the AMF-related key and a PDU session establishment request encrypted through the SMF-related key to a base station, wherein the message encrypted through the AMF-related key includes the random number value;
receiving a PDCP message including a PDU session establishment accept encrypted through the SMF key; and
decrypting the PDU session establishment accept through the SMF key.

14. The method of claim 13, wherein each of at least one network function (NF) and the base station directly exchanges communication-related signals based on a service based interface (SBI).

15. The method of claim 14, wherein the base station delivers a message including the message encrypted through the AMF-related key and the PDU session establishment request encrypted through the SMF-related key to the AMF based on the SBI.

16. The method of claim 14, wherein the base station directly obtains a message including the PDU session establishment accept encrypted through the SMF key from the SMF based on the SBI.

17. The method of claim 14, wherein when the established PDU session is modified, the UE encrypts a PDU session modification request through the SMF-related key and delivers the PDU session modification request to the base station,
the base station directly delivers a message including the PDU session modification request encrypted through the SMF-related key to the SMF, and
receives a message including a PDU session modification command encrypted through the SMF key from the SMF to deliver the PDU session modification command to the UE.

18. The method of claim 14, wherein when the established PDU session is released, the UE encrypts a PDU session release request through the SMF-related key and delivers the PDU session release request to the base station,
the base station directly delivers a message including the PDU session release request encrypted through the SMF-related key to the SMF, and
receives a message including a PDU session release command encrypted through the SMF key from the SMF to deliver the PDU session release command to the UE.
